(19) United States
(12) Patent Application Publication
(10) Pub. No.: US 2022/0026302 A1
(43) Pub. Date: Jan. 27, 2022

(54) APPARATUS FOR DIAGNOSING SEWAGE PIPE LEAKS

(71) Applicants: YARIN HEN, RISHON LEZION (IL); ELDAR HEN, RISHON LEZION (IL)

(72) Inventors: YARIN HEN, RISHON LEZION (IL); ELDAR HEN, RISHON LEZION (IL)

(21) Appl. No.: 17/340,127

(22) Filed: Jun. 7, 2021

(30) Foreign Application Priority Data
Jul. 27, 2020 (IL) 276310

(51) Int. Cl. G01M 3/00; F16L 55/28

(52) U.S. Cl. CPC G01M 3/005; F16L 55/28

(57) ABSTRACT

An apparatus for diagnosing leaks of a sewage pipe, the apparatus including an adaptable body being adaptable to a diameter being larger than a diameter of the sewage pipe, and a semi rigid cable for pushing the adaptable body into the sewage pipe, and therefrom beyond an end thereof, into a junction pipe element being wider than the sewage pipe, thereby the adaptable body adapts to the diameter being larger than the diameter of the sewage pipe, thereby the adaptation allows the adaptable body to block the end of the sewage pipe.

### CROSS-REFERENCE TO RELATED APPLICATIONS

This application claims the benefit of priority from Israel Patent Application No. 276310, filed Jul. 27, 2020, the disclosure of which is incorporated herein by reference.

### TECHNICAL FIELD

The invention relates to the field of sewage pipes. More particularly, the invention relates to a method and apparatus for diagnosing leaks thereof.

### BACKGROUND

FIG. 1 is a perspective view of sewage pipes at the first step of diagnosing a leak.

If diagnosing a leak 26A at a horizontal sewage pipe 20B, it is conventionally applied by the following steps.

At the first step, an elongated inflatable body 32 is inserted through a sewage inlet 12 into horizontal sewage pipe 20B.

FIG. 2 is a side view of the sewage pipes of FIG. 1 at the second and third steps of diagnosing the leak.

At the second step, an air pump 34 inflates elongated inflatable body 32 through a pipe 35, thus blocking horizontal sewage pipe 20B.

At the third step, water is poured into sewage inlet 12 into horizontal sewage pipe 20B, thus increased amount of water leaks and thus leak 26A being discovered.

However, and referring again to FIG. 1, elongated inflatable body 32 cannot indicate a leak 26B disposed at junction 18 of a vertical sewage pipe 20A and horizontal sewage pipe 20B, thus being disposed at a junction pipe element 24.

There is a long felt need to provide a solution to the above-mentioned and other problems of the prior art.

### SUMMARY

An apparatus is provided for diagnosing leaks, including an adaptable body, and a semi rigid cable for pushing the adaptable body.

### BRIEF DESCRIPTION OF THE DRAWINGS

Embodiments, features, and aspects of the invention are described herein in conjunction with the following drawings:

FIG. 1 is a perspective view of sewage pipes at the first step of diagnosing a leak.

FIG. 2 is a side view of the sewage pipes of FIG. 1 at the second and third steps of diagnosing the leak.

FIG. 3 is a side view of an apparatus for diagnosing leaks, according to one embodiment of the invention, at the first step of use.

FIG. 4 is a side view of the apparatus of FIG. 3 at the second and third steps of use.

FIG. 5 is the side view of the apparatus of FIG. 3 according to another embodiment.

FIG. 6 is the side view of the apparatus of FIG. 3 upon the insertion of FIG. 4 of the adaptable body into the junction sewage of FIG. 4.

FIG. 7 is a side view of the adaptable 46 of FIG. 5.

FIG. 8 is a perspective view of the adaptable 46 of FIG. 7.

FIG. 9 is a top view of the apparatus of FIG. 3 according to another embodiment, at the first step of use.

FIG. 10 is a side view of the apparatus of FIG. 9, at the second step of use.

FIG. 11 is the top view of the apparatus of FIG. 9, at the state the body has entered the junction pipe element.

FIG. 12 is the top view of the apparatus of FIG. 9, upon pulling the semi rigid cable.

FIG. 12 is the top view of the apparatus of FIG. 9, upon pulling the semi rigid cable.

FIG. 13 is the side view of the apparatus of FIG. 9, upon pulling the semi rigid cable.

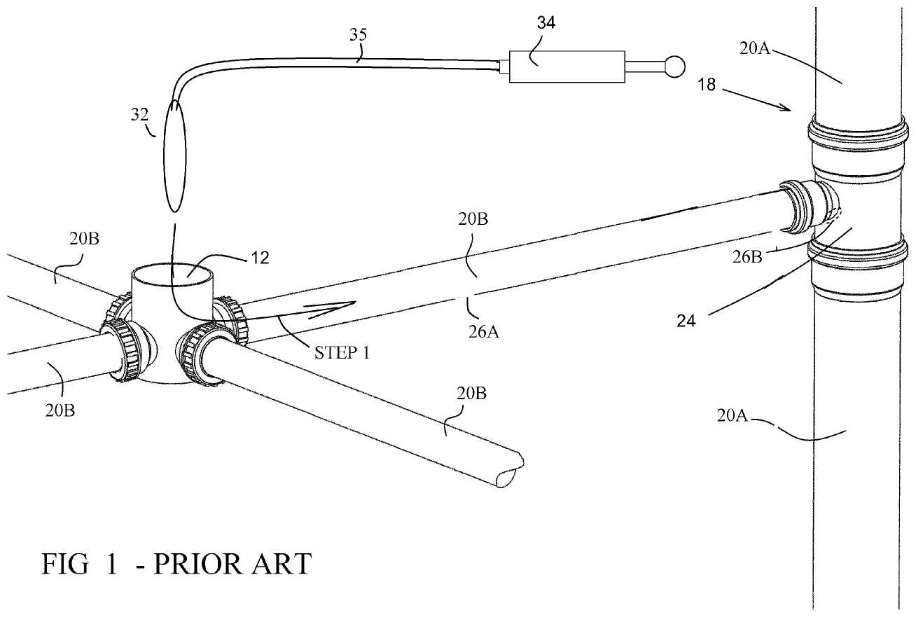

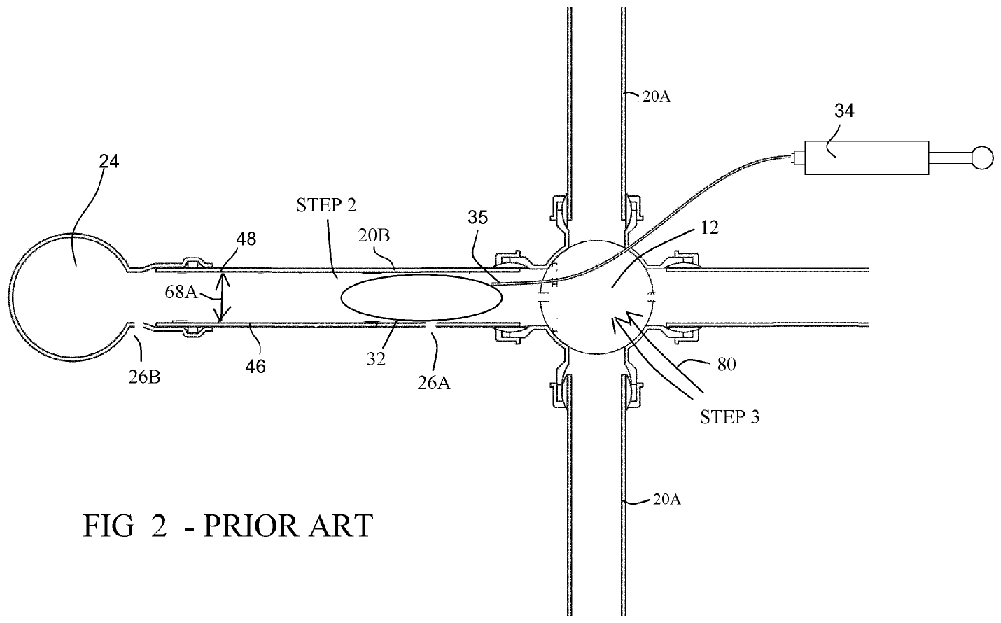

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

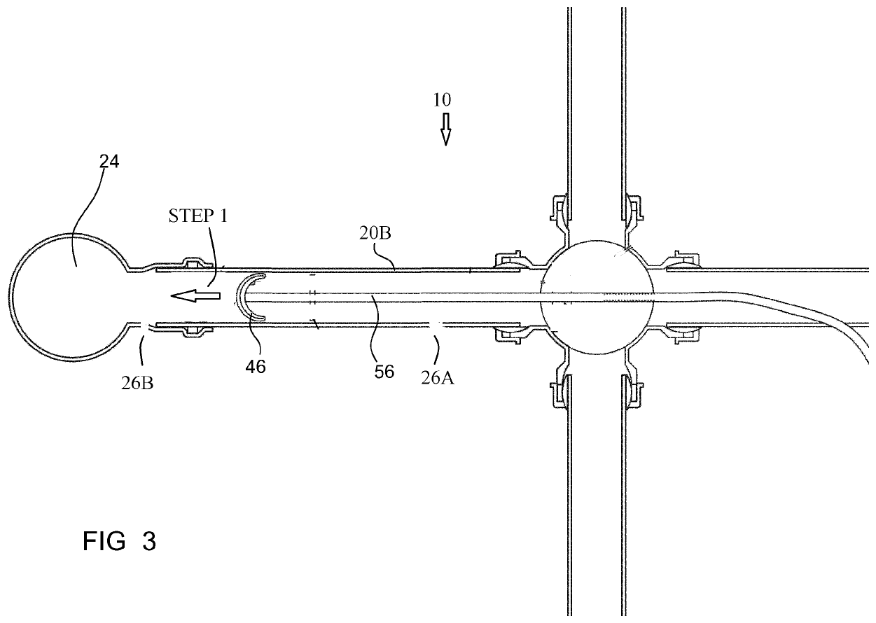

FIG. 3 is a side view of an apparatus for diagnosing leaks, according to one embodiment of the invention, at the first step of use.

An apparatus 10 for diagnosing leaks includes according to one embodiment an adaptable body 46; and a semi rigid cable 56 for locating adaptable body 46.

At the first step, adaptable body 46 is inserted into horizontal sewage pipe 20B by pushing semi rigid cable 56.

According to one embodiment, adaptable body 46 adapts, thereby blocks horizontal sewage pipe 20B, thus water may be poured into horizontal sewage pipe 20B, for discovering leak 26A.

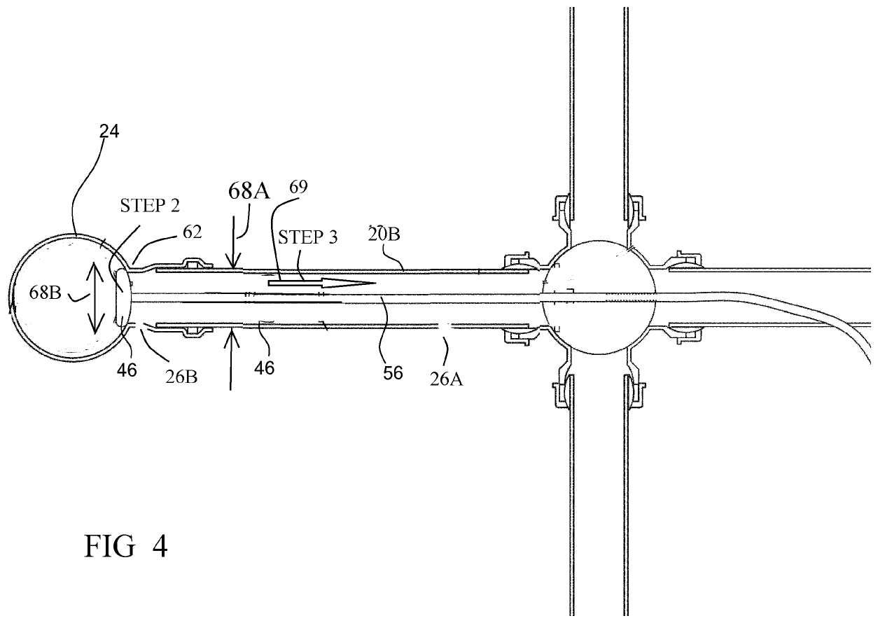

FIG. 4 is a side view of the apparatus of FIG. 3 at the second and third steps of use.

At the second step, adaptable body 46 is further inserted into junction pipe element 24, by further pushing semi rigid cable 56.

Consequently, adaptable body 46 adapts to be wider than the diameter 68A of horizontal sewage pipe 20B.

At the third step, the user pulls (69) adaptable body 46 back towards horizontal sewage pipe 20B, thus blocking the end 62 of horizontal sewage pipe 20B being adjacent to junction pipe element 24.

Water is then poured into sewage inlet 12 into horizontal sewage pipe 20B, thus leak 26B is diagnosed.

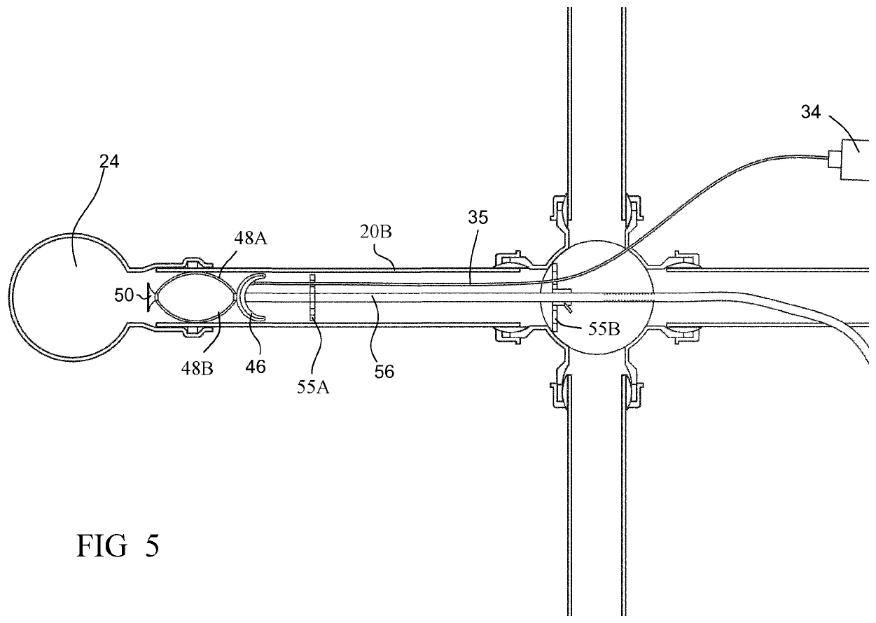

FIG. 5 is the side view of the apparatus of FIG. 3 according to another embodiment.

Semi rigid cable 56 may be disposed centralized by centering elements 55A and 55B.

Adaptable body 46 may be inflatable, for being inflated through pipe 35 by air pump 34.

Springy leaves 48A and 48B may extend from adaptable body 46.

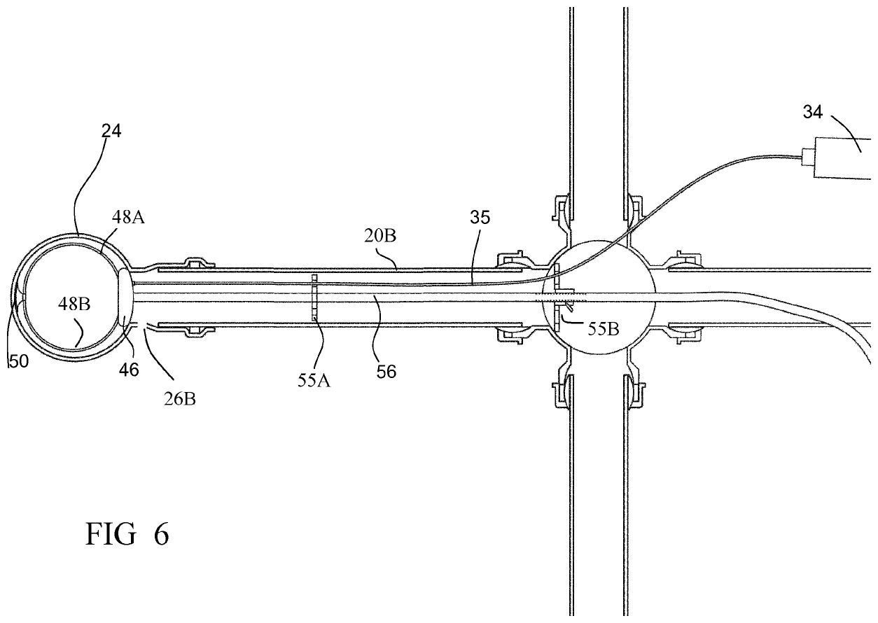

FIG. 6 is the side view of the apparatus of FIG. 3 upon the insertion of FIG. 4 of the adaptable body into the junction sewage of FIG. 4.

Upon the insertion of adaptable body 46 into junction sewage 24, springy leaves 48A and 48B adapt to the walls of junction pipe element 24.

Springy leaves 48A and 48B do not block water.

A vacuum sticker 50 may be attached to any of springy leaves 48A and 48B, for attaching a portion thereof to junction pipe element 24, for improving the blocking provided by adaptable body 46.

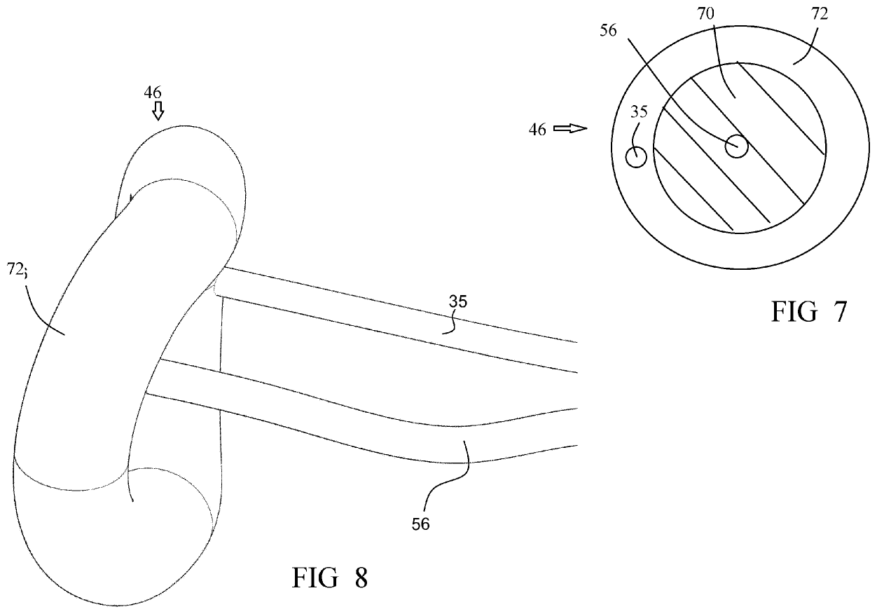

FIG. 7 is a side view of the adaptable 46 of FIG. 5.

Adaptable body 46 may include a flat round surface 70; and a round inflatable tube 72, for deploying flat round surface 70.

FIG. 8 is a perspective view of the adaptable 46 of FIG. 7.

Semi rigid cable 56 may be fixed to flat round surface 70; and pipe 35 may communicate to round inflatable tube 72.

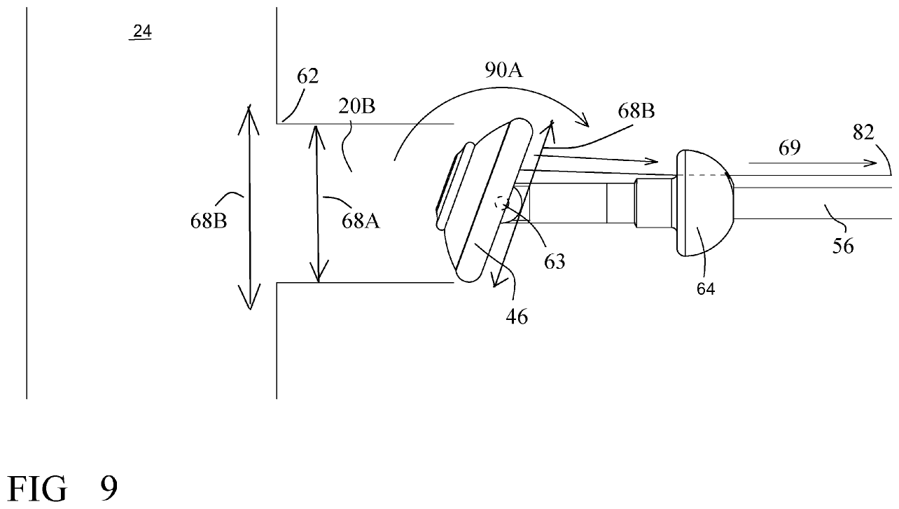

FIG. 9 is a top view of the apparatus of FIG. 3 according to another embodiment, at the first step of use.

Body 46 may be adaptable to seal diameter 68B larger than diameter 68A of sewage pipe 20B, by initially having diameter 68B. Even though, body 46 is insertable into sewage pipe 20B by rotating (90A) body 46 in relation to semi rigid cable 56 about a hinge 63, by pulling (69) a wire 82, end thereof fixed to a side of body 46.

Rotation 90A of body 46 in relation to semi rigid cable 56 about hinge 63 allows insertion of body 46 into sewage pipe 20B only regarding the surface of rotation 90A depicted in the top view of FIG. 9.

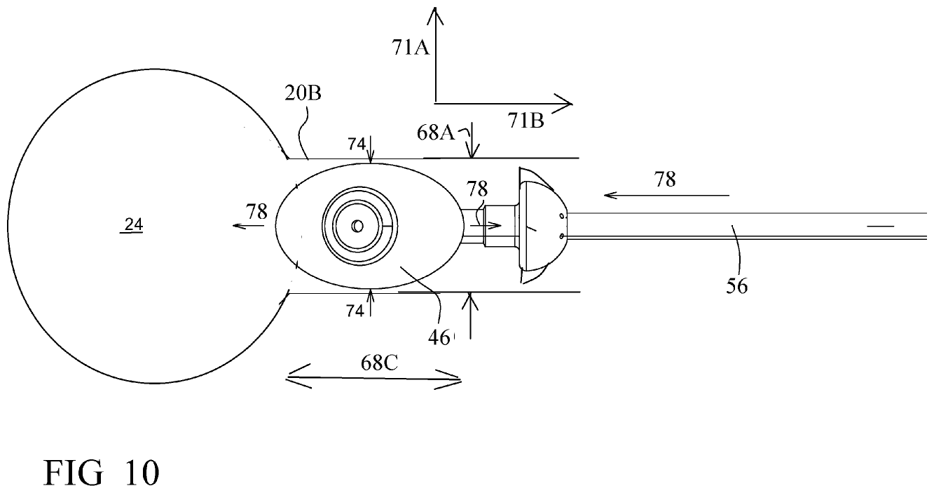

FIG. 10 is a side view of the apparatus of FIG. 9, at the second step of use.

Insertion of body 46 into sewage pipe 20B regarding the surface of the side view of FIG. 10 is allowed due to resiliency of body 46, to compress (74) axis 71A of body 46 to the size of diameter 68A being smaller than the basic diameter 68B of body 46. Compression 74 enlarges axis 71B of body 46 to a size 68C being larger than the basic diameter 68B of body 46.

Rotation 90A is required for allowing housing axis 71B of body 46 having size 68C being larger than diameter 68A of sewage pipe 20B within sewage pipe 20B.

The user presses (78) semi rigid cable 56 until body 46 enters junction pipe element 24.

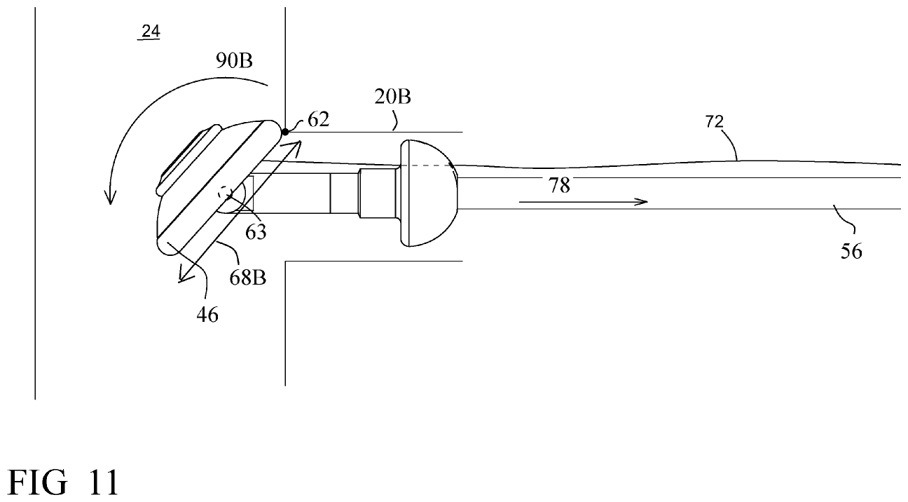

FIG. 11 is the top view of the apparatus of FIG. 9, at the state the body has entered the junction pipe element.

At this state compression 74 ceases, thus the size of body 46 at both axes is again 68B.

At the next step, the user pulls (68) semi rigid cable 56, without pulling wire 82. Since diameter 68B of body 46 is larger than diameter 68A of sewage pipe 20B, pulling 68 rotates (90B) body 46 to be right angled to semi rigid cable 56.

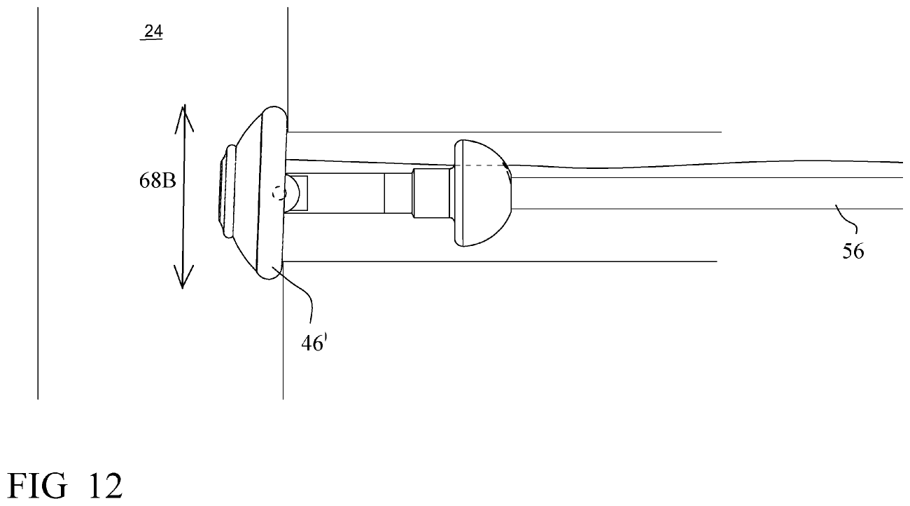

FIG. 12 is the top view of the apparatus of FIG. 9, upon pulling the semi rigid cable.

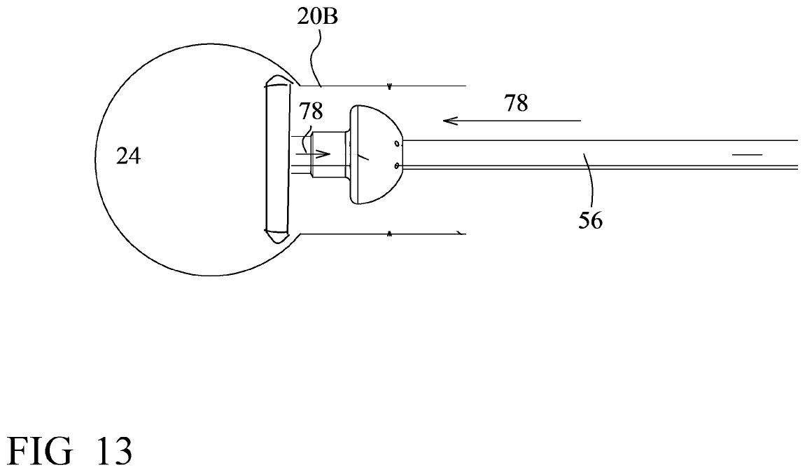

FIG. 13 is the side view of the apparatus of FIG. 9, upon pulling the semi rigid cable.

Thus, pulling 68 blocks sewage pipe 20B at both axes in a sealed manner.

Thus, in one aspect, the invention is directed to an apparatus (10) for diagnosing leaks (26A,26B) of a sewage pipe (20B), the apparatus including:
a body (46) being insertable into the sewage pipe (20B) and adaptable to seal a diameter (68B) larger than a diameter (68A) of the sewage pipe (20B); and
at least one element (48A,48B,56,82,63) for pressing the adaptable body (46) into the sewage pipe (20B) and thereon beyond an end (62) of the sewage pipe (20B), into a junction pipe element (24) being wider than the sewage pipe (20B),

thereby the adaptable body (46) adapts to the diameter (68B) being larger than the diameter (68A) of the sewage pipe (20B),

thereby the adaptation of the adaptable body (46) followed by the pressing (69) of the adaptable body (46) onto the sewage pipe (20B) from beyond the end (62) of the sewage pipe (20B), sealably blocks the end (62) of the sewage pipe (20B).

The at least one element (48A,48B,56,82,63) for pressing the adaptable body (46) may include a semi rigid cable (56), configured for pulling the adaptable body (46) towards the end (62) of the sewage pipe (20B).

The at least one element (48A,48B,56,82,63) for pressing the adaptable body (46) may include at least one springy leaf (48A,48B), for being adapted to the junction pipe element (24).

The apparatus (10) may further include a vacuum sticker (50), for attaching a portion of the at least one springy leaf (48A,48B) to a portion of the junction pipe element (24).

The at least one element (48A,48B,56,82,63) for pressing the adaptable body (46) may include:
a semi rigid cable (56), configured for distantly pushing and pulling the adaptable body (46);
a hinge (63) for allowing rotating (90A,90B) the adaptable body (46) in relation to the semi rigid cable (56); and
a wire (82) for distantly applying the rotation (90A,90B).

The adaptability of the adaptable body (46) may be: expandability, inflatability, resiliency, rotatability.

The apparatus (10) may further include an air pump (34) for inflating the adaptable body (46).

The adaptable body (46) may include:
a flat round surface (70); and
a round inflatable tube (72), for deploying the flat round surface (70).

In the figures and/or description herein, the following reference numerals (Reference Signs List) have been mentioned:
numeral 10 denotes the apparatus for diagnosing leaks according to one embodiment of the invention;
12: sewage inlet;
18: junction of sewage pipes;
20A,20B: sewage pipes;
24: junction pipe element 24;
26A,26B: undesired holes in pipes, providing leaks;
32: inflatable body;
34: air pump;
35: air pipe;
46: adaptable body;
48A,48B: springy mechanical leaves;
50: vacuum sticker;
55A,55B: centering elements;
56: semi rigid cable;
62: end of sewage pipe, providing a junction;
63: hinge;
64: centralizing element;
68A: diameter of sewage pipe 20B;
68B: diameter larger than diameter 68A;
69: pulling of wire 82;
70: flat round surface;
71A,71B: axes;
72: round inflatable tube;
74: compression of adaptable body 46 along axis 71A;
78: pressing to push and to pull semi rigid cable 56;
80: water;
82: wire;
90A,90B: rotation;

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. An apparatus for diagnosing leaks of a sewage pipe, said apparatus comprising:
a body being insertable into said sewage pipe and adaptable to seal a diameter larger than a diameter of said sewage pipe; and
at least one element for pressing said adaptable body into said sewage pipe and thereon beyond an end of said sewage pipe, into a junction pipe element being wider than said sewage pipe,
thereby said adaptable body adapts to said diameter being larger than said diameter of said sewage pipe,
thereby said adaptation of said adaptable body followed by said pressing of said adaptable body onto said sewage pipe from beyond said end of said sewage pipe, sealably blocks said end of said sewage pipe.

2. The apparatus according to claim 1, wherein said at least one element for pressing said adaptable body comprises a semi rigid cable, configured for pulling said adaptable body towards said end of said sewage pipe.

3. The apparatus according to claim 1, wherein said at least one element for pressing said adaptable body comprises at least one springy leaf, for being adapted to said junction pipe element.

4. The apparatus according to claim 3, further comprising a vacuum sticker, for attaching a portion of said at least one springy leaf to a portion of said junction pipe element.

5. The apparatus according to claim 1, wherein said at least one element for pressing said adaptable body comprises:
a semi rigid cable, configured for distantly pushing and pulling said adaptable body;
a hinge for allowing rotating said adaptable body in relation to said semi rigid cable; and
a wire for distantly applying said rotation.

6. The apparatus according to claim 1, wherein said adaptability of said adaptable body comprises at least one character selected from a group consisting of: expandability, inflatability, resiliency, rotatability.

7. The apparatus according to claim 1, further comprising an air pump for inflating said adaptable body.

8. The apparatus according to claim 1, wherein said adaptable body comprises:
a flat round surface; and
a round inflatable tube, for deploying said flat round surface.
